(19) United States
(12) Patent Application Publication
(10) Pub. No.: US 2018/0297257 A1
(43) Pub. Date: Oct. 18, 2018

(54) A SINGLE-PIECE CONSOLE MOUNTING ARMREST BRACKET

(71) Applicant: MOTHERSON AUTOMOTIVE TECHNOLOGIES & ENGINEERING (A DIVISION OF MOTHERSON SUMI SYSTEMS LTD.), Noida (IN)

(72) Inventor: IN MUK PARK, Incheon (KR)

(21) Appl. No.: 15/767,997

(22) PCT Filed: Oct. 10, 2016
(86) PCT No.: PCT/IB2016/056049

§ 371 Date: Apr. 12, 2018

(30) Foreign Application Priority Data
Oct. 14, 2015 (IN) 3314/DEL/2015

(51) Int. Cl. B29C 45/33; B60N 2/75; B29C 45/26; B29C 45/00

(52) U.S. Cl. CPC B29C 45/332; B60N 2/793; B60R 2011/0007; B29C 45/0001; B29C 45/2628

(57) ABSTRACT

A single-piece mounting console armrest is disclosed that is efficient with respect to reliability, strength, complexity as well as cost and time. The invention is also configured to use a gas-assisted moulding process in a better and enhanced manner in order to prepare/manufacture the single piece console mounting armrest, comprising of hinge/s [104] and base [106].

### FIELD OF THE INVENTION

The present invention generally relates to automotive interior structures and is more specifically directed to a single-piece console mounting armrest bracket manufactured by gas assisted injection moulding.

### BACKGROUND OF INVENTION

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and therefore, unless otherwise indicated, it should not be assumed that any of the approaches described in this section qualify as prior art merely by virtue of their inclusion in this section.

Commercially available mounting brackets are generally formed by assembling supporting portions disposed on either side of the armrest for pivotally supporting the armrest and further includes a mounting portion for fixedly attaching the bracket and armrest assembly to the seat assembly. However, as can be appreciated, the assembly requiring contact between the armrest and the bracket by way of a pivot pin through the aperture often causes rapid frictional wear on the bracket assembly and pins. The prior art has attempted to reduce the frictional wear in assembly by providing polymeric washer or spacers between the bracket and the sides of the armrest, however, the entire assembly, of all the said parts poses additional disadvantages. In addition, this process is not only time consuming but also complex.

It is also known in the prior art to form a hinge-structure by placing sheet metal brackets against a rigid substrate, wherein such structure is installed using screws, thereby requiring extra resources as well as additional time in manufacturing process. Such known methods of manufacturing armrests typically require a series of multiple and separate moulding and assembly steps which can add significant cost to each part produced. Moreover, in some of the prior art methods, formation of separate layers is a tedious process since such layers are difficult to be adhered together with screws and align precisely, which again add cost to the process. Also, the layers might result in increase in weight, cost, time etc., all of which is highly undesirable.

Hence, in view of the above and other limitations of the existing armrest assembly, there exists a need for developing a more efficient and single piece console mounting armrest bracket for the same with enhanced properties such as cost effectiveness, time saving, aesthetically pleasing, easy to assemble and install, and provides comfort and convenience to the users.

### SUMMARY OF INVENTION

This section is provided to introduce certain objects and aspects of the disclosed methods and systems in a simplified form that are further described below in the detailed description. This summary is not intended to identify the key features or the scope of the claimed subject matter.

In view of the shortcomings of existing methods and systems, as discussed in the background section, it is apparent that there exists a need to provide an integrated console mounting armrest bracket, prepared by using gas-assisted injection moulding. Another object of the present invention is to provide a single piece console mounting armrest bracket with enhanced physical properties such as higher rigidity, enhanced aesthetics, with reduced intensity and number of weld or knit lines, etc. Yet another object of the present invention is to reduce significantly the cost, time and effort in separate moulding and assembling the parts of the integrated mounting armrest by constructing an integrated structure for placing an armrest.

Accordingly, the present invention relates to a single piece console mounting armrest bracket. The single piece console mounting armrest bracket comprises at least one hollow hinge bearing at least one inlet means, the hinge being connected to a partially hollow base, wherein said armrest is prepared by gas assisted injection moulding.

Other objects, features, and advantages of the present invention will become apparent from the following detailed description.

### BRIEF DESCRIPTION OF THE DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Also, the embodiments shown in the figures are not to be construed as limiting the invention, but the possible variants of the method and system according to the invention are illustrated herein to highlight the advantages of the invention.

FIG. 1a illustrates the single piece console mounting armrest bracket as conceived by the invention in a preferred embodiment.

FIG. 1b illustrates the position of injection point on the single piece console mounting armrest bracket in accordance with an exemplary embodiment of the present invention.

FIG. 2 illustrates a cross-sectional view of a gas channel through the mould showing the filing of the thermoplastic material and the gas, thereby forming a hollow structure.

FIGS. 3a and 3b illustrate the direction of load/force on the armrest bracket for rigidity test in accordance with an exemplary embodiment of the present invention.

FIGS. 4a and 4b illustrate the direction of load/force on the armrest bracket for static fitness test in accordance with an exemplary embodiment of the present invention.

FIG. 5 illustrates assembling process of said single piece console mounting armrest bracket as encompassed by the present invention.

It may be evident to skilled artisans that elements in the figures are only illustrative, for simplicity and clarity, and have not necessarily been drawn to scale. For example, the dimensions of some of the elements in the figures may be exaggerated relative to other elements to help to improve understanding of embodiments of the present invention.

### DETAILED DESCRIPTION OF EXEMPLARY EMBODIMENTS

In the following description, for the purposes of explanation, various specific details are set forth in order to provide a thorough understanding of the disclosed embodiments. It will be apparent, however, that the disclosed embodiments may be practiced without these specific details. Several features described hereafter can each be used independently of one another or with any combination of other features. However, any individual feature may not address any of the problems discussed above or might address only some of the problems discussed above. Some of the problems discussed above might not be fully addressed by any of the features described herein.

Techniques are encompassed for manufacturing of a single piece console mounting armrest bracket of a vehicle, to ensure that all hassles and problems associated with the same of said parts are avoided. The terms “integrated mounting armrest bracket” and “mounting structure” have been used interchangeably throughout the specification. The terms “integrated” and “single piece” have been used interchangeably throughout the specification.

The present invention relates to a single piece console mounting armrest bracket and a method thereof. Said method for manufacturing an a single piece console mounting armrest bracket of a vehicle prepared by the gas-assisted injection moulding process, wherein said vehicle may include, but not limited to, four-wheelers (such as car, truck, bus, van) and airplanes.

The present invention is primarily focused on a single piece console mounting armrest bracket that comprises at least one hollow hinge bearing at least one inlet means, and a partially hollow base, wherein said hinge is connected to said base. The armrest bracket is prepared by gas assisted injection moulding which further comprises injection of a pressurized gas with pre-determined parameters into a mould via said inlet means, wherein said mould is of desired shape of the armrest and partially filled with molten substrate such that the gas when injected pushes said molten substrate into the mould and creates a hollow cavity at desired locations within the armrest, the armrest being devoid of any outlet means. This process is further explained in the specification.

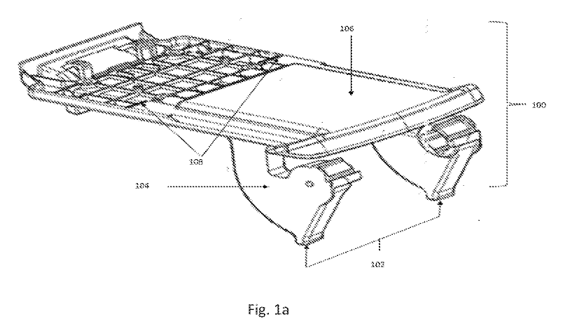

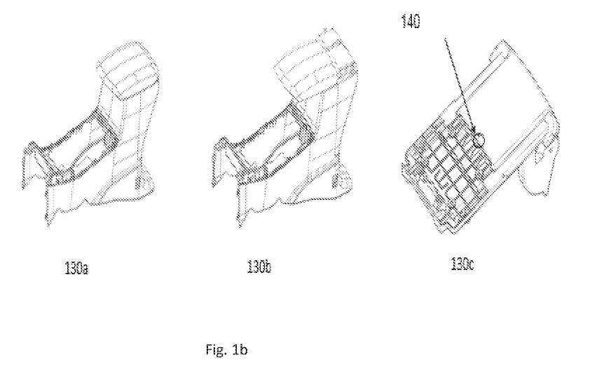

FIG. 1a illustrates a single piece console [100] armrest bracket. Said armrest bracket comprises a base [106] and at least one hinge [104] that are attached/connected to each other by way of gas assisted moulding technique, wherein said at least one hinge [104] is completely hollow and wherein said base [106] is partially hollow and wherein the gas is injected inside the hinge [104] such that it is devoid of any outlet and thus eliminates the need of outlets in said hinge [104]. Further, the hinge [104] comprises at least one hole on both the sides of said hinge [104] for smooth installation of shafts for further easy rotation. Also, the hinge [104] comprises at least one inlet [102]. In an embodiment, the inlet for injection [102] of the gas lies at the edges of the hinges [104]. Accordingly, said structure of bracket [100] only comprises inlets [102] in the hinges [104] so that a desired certain amount of gas is injected inside making the structure hollow up to a desired point along the sides only [108]. The structure of said bracket [100] therefore does not require any outlet as the hollow/cavity is created up to a desired position of the structure [100].

Furthermore, said base [106] comprises an injection point [140]. An exemplary embodiment of the invention illustrates three cases of armrest bracket, wherein FIG. 130a illustrates normal armrest i.e. before sliding; FIG. 130b illustrates the armrest after sliding and FIG. 130c illustrates the expanded view of the base of said armrest bracket Here, it is observed that the position of said injection point [140] is visible only before the sliding of the armrest and is further not visible after the sliding of said base. However, a thick TM structure would suffer from contortions if it is entirely solid and therefore for structural stability of the integrated bracket/armrest bracket [100], it is essential to make it hollow which is done by injecting gas at predefined temperature for a pre-defined time in a predefined volume so at to create a hollow space inside the structure.

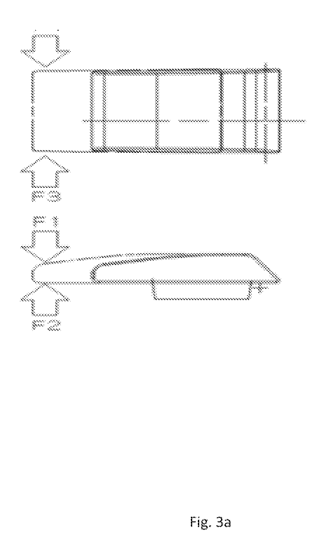

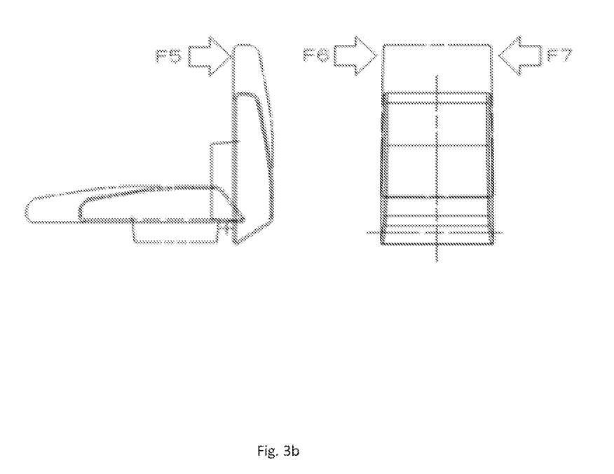

The present invention encompasses that said single piece console mounting armrest bracket [100] is manufactured in order to provide load capacity. Since the interned assembled components are resting on the said bracket [100] and hinge [104] further enables rotation of said armrest with the help of mounting legs, therefore, said bracket [100] is enabled to bear load requirement, Said load requirement is typically decided/determined on the basis of rigidity check test and static stiffness test. In an exemplary embodiment of the present invention, as illustrated in FIGS. 3a and 3b, for rigidity check test, direction of load is determined to check the condition of console component equivalent to the vehicle. For instance, at a rotation angle of 0 degree, maximum load of 100 Newton (N) (F1, F2, F3 and F4) and minimum load of 50 Newton (N) (F5, F6 and F7) may be encompassed by the bracket.

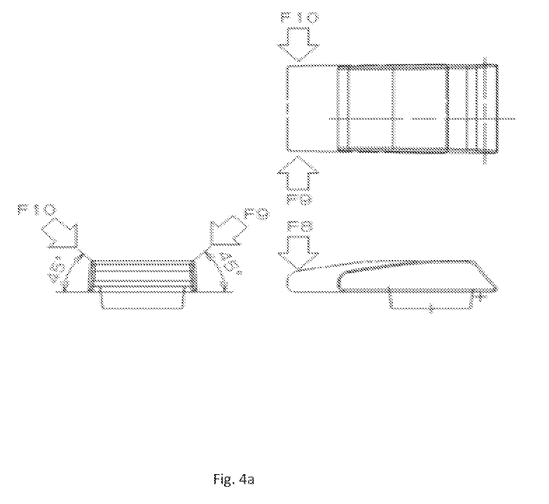

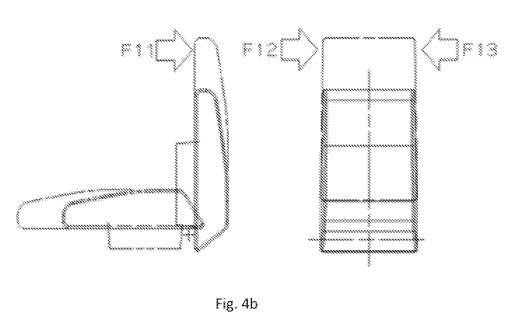

In an exemplary embodiment of the present invention, as illustrated in FIGS. 4a and 4b, for static stiffness test, direction of load in this figure is illustrated. Further, the condition of console component equivalent to the vehicle is determined/checked. For instance, at a rotation angle of 0 degree and maximum slide stroke, the load may include 100 N (F9, F10), 500 N (F8) and 1000 N (F11, F12 and F13). Also, the rotation and sliding armrest do not possess any abnormality/disadvantage such as poor actuation, deformation, gap effects, noise etc.

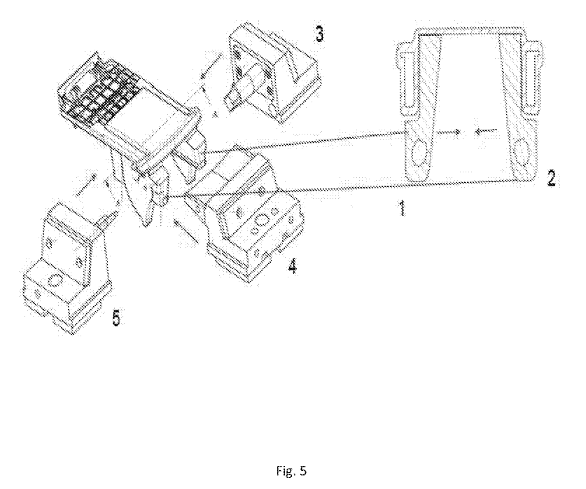

Furthermore, FIG. 5 illustrates assembling of said single piece console mounting armrest bracket. More particularly, FIG. 5 depicts step by step mechanism for the assembling process with the help of 5 sliders [1, 2, 3, 4, and 5] that are configured to produce an integrated and assembled single piece console mounting armrest bracket. More particularly, the single piece console mounting armrest bracket is formed in an injection tool using sliders and lifter mechanism such that it results in improved appearance and structural specifications.

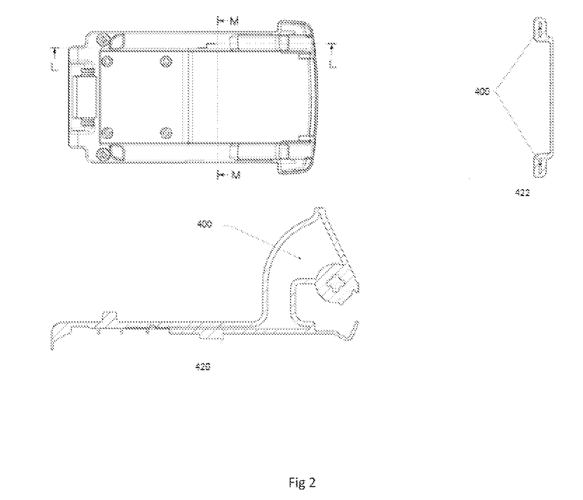

In addition, said single piece console mounting armrest is manufactured by using an injection moulding machine/equipment/apparatus/system and further prepared by gas-assisted injection moulding, wherein the gas received by the receiver is passed to the at least one nozzle through at least one gas channel that is strategically designed based upon various parameters such as properties of the substrate, load capacity of said armrest bracket, etc. In an exemplary embodiment of the present invention and as shown in FIG. 2, the gas channel comprises a valley/defile in accordance with the load requirements. Also, it comprises at least two integrated elements/components in order to eliminate secondary process example screwing Snapping etc. Further, the sections, L-L section [420] and M-M section [422] are configured for improved load capacity and substantive increased load strength. Also, said sections [420, 422] are capable of optimizing and balancing said load over the entire system/bracket [100]. The gas and the substrate then flow into the at least one mould through said nozzle, wherein said gas is inserted in typical sections of the mould. In an exemplary embodiment of the present invention, the gas is inserted in 5 sections, as illustrated in FIG. 5. Finally, the gas and the substrate in said mould are allowed to cool down, wherein said cooling solidifies the same. Subsequently, the gas is vented from the mould, thereby resulting in formation of an integrated console mounting structure (for integrated mounting armrest bracket), wherein said integrated console mounting structure bracket comprises a hollow cavity, either partial or complete.

However, a person skilled in the art may be cognizant of the fact that the manufacturing/mounting of the single piece console mounting armrest bracket may vary from armrest to armrest for efficient results/outcomes. Thus, the present invention encompasses manufacturing of single piece console mounting armrest bracket to not only overcome the afore-mentioned drawbacks of the prior art but also to provide an improved integrated console mounting armrest bracket with optimized and integrated structure.

Although the present disclosure has been described in considerable detail with reference to certain preferred embodiments and examples thereof, other embodiments and equivalents are possible. Even though numerous characteristics and advantages of the present disclosure have been set forth in the foregoing description, together with functional and procedural details, the disclosure is illustrative only, and changes may be made in detail. Thus various modifications are possible of the presently disclosed system and process without deviating from the intended scope and spirit of the present disclosure.

We claim:

1. A single piece console mounting armrest bracket, comprises at least one hollow hinge bearing at least one inlet means, the hinge being connected to a partially hollow base, wherein said armrest is prepared by gas assisted injection moulding.

2. The single piece console mounting armrest bracket as claimed in claim 1, wherein the material used for making said bracket is one of thermoplastic amides, thermoplastic olefins, polyvinyl chloride, polypropylene and combination thereof.

3. The single piece console mounting armrest bracket as claimed in claim 1, wherein said bracket is formed by using an injection tool along with sliders and lifter mechanisms.

4. The single piece console mounting armrest bracket as claimed in claim 1, wherein said single piece console mounting bracket further comprises an injection point at said base.

5. The single piece console mounting armrest bracket as claimed in claim 1, wherein said mounting armrest bracket is configured to support load bear requirement.
